(19) United States
(12) Patent Application Publication
(10) Pub. No.: US 2023/0044868 A1
(43) Pub. Date: Feb. 9, 2023

(54) NICKEL-BASED SUPERALLOY WITH HIGH VOLUME FRACTION OF GAMMA STRENGTHENING PHASE FOR ADDITIVE MANUFACTURING AND ADDITIVE MANUFACTURING METHOD FOR HIGH-TEMPERATURE MEMBERS USING SAME

(71) Applicants: CHANGWON NATIONAL UNIVERSITY INDUSTRY UNIVERSITY CORPORATION FOUNDATION, Changwon-si (KR); KOREA INSTITUTE OF INDUSTRIAL TECHNOLOGY, Cheonan-si (KR)

(72) Inventors: Hyun Uk Hong, Changwon-si (KR); Ji un Park, Busan (KR); Byoung Soo Lee, Gangneung-si (KR); Hae-Jin Lee, Gangneung-si (KR)

(21) Appl. No.: 17/658,080

(22) Filed: Apr. 5, 2022

(30) Foreign Application Priority Data
Jul. 22, 2021 (KR) 10-2021-0096673

(51) Int. Cl. C22C 19/05; B33Y 10/00; B33Y 70/00; B33Y 40/20; C22F 1/10; B22F 10/28; B22F 10/64; B23K 15/00

(52) U.S. Cl. CPC C22C 19/056; B33Y 10/00; B33Y 70/00; B33Y 40/20; C22F 1/10; B22F 10/28; B22F 10/64; B23K 15/0086; B22F 2301/15

(57) ABSTRACT

This application relates to a nickel-based superalloy suitable for additive manufacturing and a method for manufacturing a high-temperature member using the same. The nickel-based superalloy includes 13.7% to 14.3% by weight of Cr, 9.0% to 10.0% by weight of Co, 3.7% to 4.3% by weight of Mo, 2.6% to 3.4% by weight of Ti, 3.7% to 4.3% by weight of W, 2.6% to 3.4% by weight of Al, 0.15% to 0.19% by weight of C, greater than 0% by weight and not less than 0.005% by weight of B, 0.01% to 0.05% by weight of Zr, 2.0% to 2.7% by weight of Ta, 0.6% to 1.1% by weight of Hf, Ni residue, and unavoidable impurities. The nickel-based superalloy has a high fraction of [symbol] strengthening phase, thereby maintaining excellent high-temperature strength. Additive manufacturing with the nick-based superalloy is much easier than existing nickel-based superalloys, thereby cost-effectively providing maximized cooling efficiency.

### CROSS REFERENCE TO RELATED APPLICATION

The present application claims priority to Korean Patent Application No. 10-2021-0096673, filed on Jul. 22, 2021, the entire contents of which is incorporated herein for all purposes by this reference.

### BACKGROUND

### Technical Field

The present disclosure relates to a nickel-based superalloy for additive manufacturing and, more particularly, the present disclosure relates to a nickel-based superalloy with high volume fraction of [symbol] strengthening phase for additive manufacturing, which has excellent corrosion resistance and high-temperature mechanical properties and may be used in high-temperature environments such as a power generation gas turbine, an aviation jet engine, and a high-temperature gas cooling furnace.

### Description of Related Technology

In the case of nickel-based superalloys, which are used as high-temperature core parts for gas turbines for aviation and power generation, the development of parts using an additive manufacturing method is actively being attempted in line with the 4th industrial revolution.

On the other hand, the nickel-based superalloys have high-temperature strength as the volume fraction of [symbol] , which is a high-temperature strengthening phase, increases. All superalloys with a high-fraction [symbol] strengthening phase ( [symbol] fraction of 40% or more) are manufactured to the parts through investment casting. Superalloys having a high-fraction [symbol] phase have very good high-temperature strength and have temperature tolerance up to 1050° C., but are classified as difficult-to-weld materials due to poor weldability.

### SUMMARY

The technical problem to be solved by the present disclosure is to provide a nickel-based superalloy suitable as a material for additive manufacturing while having a high-fraction [symbol] phase and a method for additive manufacturing of a high-temperature member using the same.

In order to achieve the above technical problem, the present disclosure provides a nickel-based superalloy for additive manufacturing, the nickel-based superalloy includes: 13.7 to 14.3% by weight of Cr; 9.0 to 10.0% by weight of Co; 3.7 to 4.3% by weight of Mo; 2.6 to 3.4% by weight of Ti; 3.7 to 4.3% by weight of W; 2.6 to 3.4% by weight of Al; 0.15 to 0.19% by weight of C; greater than 0% by weight and not more than 0.005% by weight of B; 0.01 to 0.05% by weight of Zr; 2.0 to 2.7% by weight of Ta; 0.6 to 1.1% by weight of Hf; Ni residue; and unavoidable impurities.

In addition, as a more preferred example of the nickel-based superalloy for additive manufacturing, the nickel-based superalloy includes: 14.0% by weight of Cr; 9.5% by weight of Co; 4.0% by weight of Mo; 3.0% by weight Ti; 4.0% by weight of W; 3.0% by weight of Al; 0.17% by weight of C; 0.005% by weight of B; 0.03% by weight of Zr; 2.5% by weight of Ta; 1.0% by weight of Hf; Ni residue; and unavoidable impurities.

In addition, the nickel-based superalloy for additive manufacturing further includes 0.01 to 0.1% by weight of at least one alloy element selected from the group consisting of Nb and rare earth elements (RE).

In this case, the rare earth element (RE) includes each of the 17 known rare earth elements as well as mischmetal.

In another aspect of the present disclosure, a method for additive manufacturing of a nickel-based superalloy high-temperature member is provided, including manufacturing a high-temperature member by additive manufacturing (AM) using the powder of the nickel-based superalloy.

As a preferred example of the method for additive manufacturing of a nickel-based superalloy high-temperature member, provided is a method of manufacturing a high-temperature member by additive manufacturing using the powder of the nickel-based superalloy prepared by gas atomization. The additive manufacturing is referred to electron beam melting (EBM) method performed according to process conditions of a focus offset of 12 to 18 mA; beam power of 300 W; scan speed of 900 to 1200 mm/s; beam current of 3 to 6 mA; and a layer thickness of 60 to 80 μm.

Further, after completing additive manufacturing through a method such as an electron beam melting (EBM), the method for additive manufacturing of a nickel-based superalloy high-temperature member is performed with heat treatment including: (a) performing solution treatment of 1210° C. to 1300° C. for 2 hours or more on the nickel-based superalloy high-temperature member, followed by air cooling or water cooling to room temperature (this step can dissolve micro-segregation and precipitates such as MC and [symbol] generated during additive manufacturing and reduce dislocation density considerably); (b) primarily aging the nickel-based superalloy high-temperature member having undergone step (a) at 1090° C. to 1100° C. for at least 4 hours, followed by air cooling or water cooling to room temperature (through this step, the cuboidal-shaped primary [symbol] phase can be precipitated with the maximum size and fraction); (c) secondarily aging the nickel-based superalloy high-temperature member having undergone step (b) at 820° C. to 840° C. for 16 hours or more, followed by air cooling or water cooling to room temperature (this step can uniformly distribute the spherical fine secondary [symbol] phase). In another aspect of the present disclosure, a nickel-based superalloy high-temperature member manufactured according to the above method is proposed.

The nickel-based superalloy suitable for additive manufacturing, according to the present disclosure, has a high fraction of [symbol] phase to maintain excellent high-temperature strength, and at the same time, it is economical because the ease of additive manufacturing is far superior to that of the existing nickel-based superalloy. Therefore, it can be usefully used for manufacturing parts with complex shapes that maximize cooling efficiency.

In addition, in the case of additive manufacturing of a nickel-based superalloy high-temperature member using the nickel-based superalloy as raw material, if the electron beam melting (EBM) method performed under specific process conditions is used, defects such as pores or cracks do not occur during the additive manufacturing process. Accordingly, a high-quality nickel-based superalloy high-temperature member having excellent high-temperature mechanical properties can be manufactured.

### BRIEF DESCRIPTION OF THE DRAWINGS

FIG. 1 is a scanning electron microscope (SEM) photograph showing powders of a commercial nickel-based superalloy (René 80) as a comparative example and a specifically designed nickel-based superalloy according to an embodiment of the present application, respectively.

FIG. 2 is a scanning electron microscope (SEM) photograph showing microstructures of a commercial nickel-based superalloy (René 80) additively manufactured specimen as a comparative example and a specifically designed nickel-based superalloy additively manufactured specimen according to the embodiment of the present application, respectively.

FIG. 3 is a scanning electron microscope (SEM) photograph showing [symbol] highlighting microstructures of a commercial nickel-based superalloy (René 80) additively manufactured specimen as a comparative example and a specifically designed nickel-based superalloy additively manufactured specimen according to the embodiment of the present application, respectively. The [symbol] fraction and size of each specimen are also included.

### DETAILED DESCRIPTION

When the nickel-based superalloys are additively manufactured, which undergo a thermo-physical phenomenon similar to welding, residual stress is excessively accumulated due to precipitation of a large amount of [symbol] during cooling, and thus cracks easily occur at high temperatures, and as a result, additive manufacturing is quite difficult.

Accordingly, until now, in order to easily apply additive manufacturing, parts have been developed by additive manufacturing using alloys with excellent weldability due to the low [symbol] fraction. However, since superalloys with a low [symbol] fraction have poor high-temperature strength, superalloys with a low [symbol] fraction cannot be used as core materials for turbines that require excellent high-temperature mechanical properties to increase the efficiency of gas turbines, so their scope of application is limited. Therefore, in order to improve the processability of additive manufacturing, microstructural stability, and mechanical properties, it is required to design an alloy with a new composition suitable for additive manufacturing methods and derive the conditions for an additive manufacturing process using the same.

In describing the present disclosure, if it is determined that a detailed description of a related known function or configuration may unnecessarily obscure the gist of the present disclosure, the detailed description thereof will be omitted.

Since the embodiment, according to the concept of this disclosure, may make various changes and have various forms, specific embodiments will be illustrated in the drawings and described in detail in this specification or application. However, this is not intended to limit the embodiment according to the concept of the present disclosure to a specific disclosed form and should be understood to include all changes, equivalents, or substitutes included in the spirit and scope of the present disclosure.

The terms used herein are used only to describe specific embodiments and are not intended to limit the present disclosure. The singular expression includes the plural expression unless the context clearly dictates otherwise. In the present specification, terms such as “comprise” or “have” are intended to designate that the described feature, number, step, operation, component, part, or a combination thereof exists, but one or more other features or numbers, it should be understood that it does not preclude the possibility of the existence or addition of steps, operations, components, parts, or combinations thereof.

Hereinafter, the present disclosure will be described in more detail by way of examples.

According to the present specification, embodiments may be modified in various other forms, and the scope of the present specification is not to be construed as being limited to the embodiments described below. The embodiments of the present specification are provided to more completely explain the present specification to those of ordinary skilled in the art.

### Example

In this embodiment, René 80 superalloy (Ni-9.5Co-14Cr-4Mo-4W-5Ti-3Al-0.17C-0.015B-0.03Zr), in which the [symbol] fraction is high as 40 to 50% to have excellent high-temperature strength and is widely applied to high-temperature parts, was selected as a reference alloy and a comparative example. An electron beam additive manufacturing was firstly performed with the René 80 superalloy.

Despite the fact that additive manufacturing was performed using various combinations of process parameters in a fairly wide range, high-temperature cracks and pores were significantly observed, and a prepared specimen was not even possible to build up to a length of more than 20 mm due to an arc blowing phenomenon.

Accordingly, the present disclosure was to design a new nickel-based superalloy customized for additive manufacturing based on the composition of René 80 alloy but with significantly improved the processability of additive manufacturing.

First, an Hf element was added to improve the columnar grain boundary ductility of the existing René 80 to prevent high-temperature cracking at the grain boundary. By replacing some Ti elements, which are known to have a low recovery rate and cause high oxidation reactions, with Ta elements, it is intended to reduce oxidation reactions, improve recovery rates, and ensure a [symbol] fraction, thereby improving the processability of additive manufacturing.

Furthermore, in order to improve the processability of additive manufacturing and at the same time ensure the high-temperature strength equivalent to or higher than that of René 80 alloy, through extensive thermodynamic-based computational analysis, a component system in which the [symbol] fraction is predicted to be more than 40% was screened.

In addition, as a component system capable of maintaining high-temperature microstructure stability, i.e., suppressing harmful phases, a nickel-based superalloy for additive manufacturing including 13.7 to 14.3% by weight of Cr; 9.0 to 10.0% by weight of Co; 3.7 to 4.3% by weight of Mo; 2.6 to 3.4% by weight of Ti; 3.7 to 4.3% by weight of W; 2.6 to 3.4% by weight of Al; 0.15 to 0.19% by weight of C; greater than 0% by weight and not more than 0.005% by weight of B; 0.01 to 0.05% by weight of Zr; 2.0 to 2.7% by weight of Ta; 0.6 to 1.1% by weight of Hf; and Ni residue was finally derived.

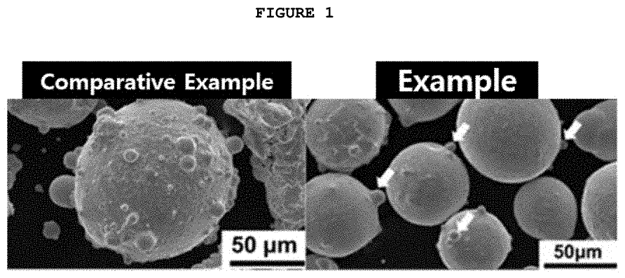

FIG. 1 is an example of powders of the nickel-based superalloy for additive manufacturing, the nickel-based superalloy includes: 14.0% by weight of Cr; 9.5% by weight of Co; 4.0% by weight of Mo; 3.0% by weight of Ti; 4.0% by weight of W; 3.0% by weight of Al; 0.17% by weight of C; 0.005% by weight of B; 0.03% by weight of Zr; 2.5% by weight of Ta; 1% by weight of Hf; and Ni residue. FIG. 1 shows the shapes of specifically designed Ni-based superalloy powder (Example) and commercial nickel-based superalloy (René 80) powder (Comparative Example) for additive manufacturing according to the present disclosure prepared by gas atomization.

As shown in FIG. 1, the conventional René 80 alloy powder has an irregular shape, and small satellite powders are attached to the surface of the large powder.

On the other hand, the alloy powder of the present disclosure exhibited a much more spherical shape, and the number of satellite powders has greatly reduced. The shape of the powder, which is the raw material of additive manufacturing, is very important for ease and quality of additive manufacturing, and the closer to a spherical shape and the smaller the satellite powder, the better for additive manufacturing. Therefore, the powder characteristics of the alloy of the present disclosure also play an advantageous role in additive manufacturing.

On the other hand, the process parameters of the electron beam melting as an additive manufacturing method are also very important in order to control the fraction and shape of y′, which are the main strengthening phase, while minimizing additive manufacturing defects such as pores and cracks.

Accordingly, the following optimal parameters for the electron beam melting process were derived in the present disclosure.
Focus offset: 12 to 18 mA
Beam power: 300 W
Scan speed: 900 to 1,200 mm/s
Beam current: 3 to 6 mA
Layer thickness: 60 to 80 μm

Based on the optimal range of process parameters for the electron beam additive manufacturing, a superalloy having a high [symbol] fraction was fabricated using the nickel-based superalloy powder at focus offset of 15 mA; beam power of 300 W; scan speed of 1,000 mm/s; beam current of 5 mA; layer thickness of 75 μm; and a line offset of 100 μm.

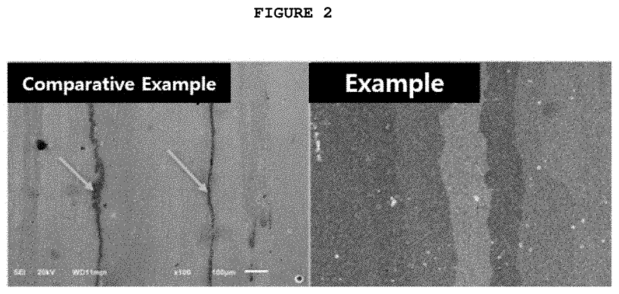

The processability of electron beam additive manufacturing was significantly improved, and it was possible to manufacture a specimen with a height of about 4 times or more. As a result of microstructure analysis, it was confirmed that hot cracking did not occur at the grain boundary due to the addition of Hf element, as shown in FIG. 2.

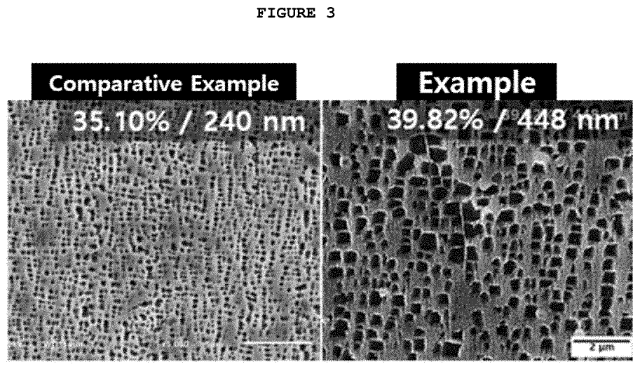

In addition, the microstructures highlighting the [symbol] character (size, shape, and fraction) through a scanning electron microscope are shown in FIG. 3. It was observed in both alloys that a significant amount of [symbol] was precipitated immediately after additive manufacturing, that is, even without post heat treatment. However, in the case of the alloy of the present disclosure, it can be seen that the [symbol] size and fraction are much larger than those of the existing René 80 alloy. In the case of additively manufactured the existing René 80 alloy, the [symbol] fraction was 35.1%, and the [symbol] average size was observed to be 240 nm. On the other hand, in the case of additively manufactured the alloy of the present disclosure, the [symbol] fraction was 39.8%, and the [symbol] average size was observed to be 448 nm, so that the [symbol] fraction was larger, and the size increased almost twice.

Considering that the higher the size and fraction of [symbol] , the higher the high-temperature strength, it may be determined that the alloy manufactured with the components of the present disclosure is excellent in the processability of additive manufacturing and in high-temperature mechanical properties.

The nickel-based superalloy for additive manufacturing, according to the present disclosure, has a high fraction of [symbol] strengthening phase to maintain excellent high-temperature strength, and at the same time, it is economical because the processability of additive manufacturing is far superior to that of the existing nickel-based superalloy. Therefore, it can be usefully used to manufacture parts with complex shapes that maximize cooling efficiency.

In addition, in the case of additive manufacturing of a high-temperature member using the nickel-based superalloy as raw material, if the electron beam melting (EBM) method performed under specific process conditions is used, defects such as pores or cracks do not occur during the additive manufacturing process. Accordingly, a high-quality nickel-based superalloy high-temperature member having excellent high-temperature mechanical properties can be manufactured.

The present disclosure is not limited to the above embodiments but may be manufactured in various different forms, and a person skilled in the art will understand that the present disclosure may be implemented in other specific forms without changing the technical idea or essential features of the present disclosure. Therefore, it should be understood that the embodiments described above are illustrative in all respects and not restrictive.

What is claimed is:

1. A nickel-based superalloy for additive manufacturing, the nickel-based superalloy comprising:
13.7% to 14.3% by weight of Cr;
9.0% to 10.0% by weight of Co;
3.7% to 4.3% by weight of Mo;
2.6% to 3.4% by weight of Ti;
3.7% to 4.3% by weight of W;
2.6% to 3.4% by weight of Al;
0.15% to 0.19% by weight of C;
greater than 0% by weight and not more than 0.005% by weight of B;
0.01% to 0.05% by weight of Zr;
2.0% to 2.7% by weight of Ta;
0.6% to 1.1% by weight of Hf;
Ni residue; and
unavoidable impurities.

2. The nickel-based superalloy of claim 1, comprising:
14.0% by weight of Cr;
9.5% by weight of Co;
4.0% by weight of Mo;
3.0% by weight of Ti;
4.0% by weight of W;
3.0% by weight of Al;
0.17% by weight of C;
0.005% by weight of B;
0.03% by weight of Zr;
2.5% by weight of Ta;
1.0% by weight of Hf;
Ni residue; and
unavoidable impurities.

3. The nickel-based superalloy of claim 1, further comprising 0.01% to 0.1% by weight of at least one alloy element selected from the group consisting of Nb and rare earth elements (RE).

4. An additive manufacturing method for a nickel-based superalloy high-temperature member, the method comprising manufacturing a high-temperature member by subjecting a powder of the nickel-based superalloy of claim 1 to an additive manufacturing process.

5. The method of claim 4, wherein the powder of the nickel-based superalloy is subjected to electron beam melting as the additive manufacturing, and wherein the electron beam melting is performed at a focus offset of 12 mA to 18 mA, a beam power of 300 W, a scan speed of 900 mm/s to 1200 mm/s, a beam current of 3 mA to 6 mA, and layer thickness of 60 μm to 80 μm.

6. The method of claim 4, wherein after completing the additive manufacturing, performing heat treatment comprising:
performing solution treatment of 1210° C. to 1300° C. for 2 hours or more on the nickel-based superalloy high-temperature member, followed by air cooling or water cooling to room temperature;
subsequent to the performing, primarily aging the nickel-based superalloy high-temperature member at 1090° C. to 1100° C. for at least 4 hours, followed by air cooling or water cooling to room temperature; and
subsequent to the primarily aging, secondarily aging the nickel-based superalloy high-temperature member at 820° C. to 840° C. for 16 hours or more, followed by air cooling or water cooling to room temperature.

7. A nickel-based superalloy high-temperature member manufactured according to the method of claim 4.
